(19) United States
(12) Patent Application Publication
(10) Pub. No.: US 2023/0225360 A1
(43) Pub. Date: Jul. 20, 2023

(54) PATATIN AS BINDER IN MEAT SUBSTITUTES

(71) Applicant: COÖPERATIE KONINKLIJKE AVEBE U.A., Veendam (NL)

(72) Inventors: Robin Eric Jacobus SPELBRINK, Scharmer (NL); Christina Lamberta Catharina SEEGERS, Groningen (NL); Nikola STANISIC, Groningen (NL); Zhenghong CHEN, Groningen (NL)

(21) Appl. No.: 18/007,138

(22) PCT Filed: Jul. 29, 2021
(86) PCT No.: PCT/NL2021/050481

§ 371 Date: Jan. 27, 2023

(30) Foreign Application Priority Data
Jul. 30, 2020 (EP) 20188554.8

(51) Int. Cl. A23J 3/22; A23J 3/16; A23L 33/185; A23L 33/12

(52) U.S. Cl. CPC A23J 3/227; A23J 3/16; A23L 33/185; A23L 33/12

(57) ABSTRACT

The invention provides a method for suppressing off-flavor formation in food products which comprise or have been prepared from a mixture comprising water, a lipid and native patatin, as well as to food products thus obtained.

Native patatin can be used in food products for various reasons, including as a gelling agent or emulsifier. In food products which furthermore comprise a lipid, and in which native patatin is in contact with the lipid, use of native patatin may under certain conditions cause the formation of off-flavors.

Patatin has been known to hydrolyze phospholipids and monoglycerides, but does not generally have hydrolytic activity on triglycerides (see for instance Hirschberg et al, Eur. J. Biochem 2001, 268, 5037, Galliard et al., Biochem. J. 1971, 121, 379 or Andrews et al, Biochem J. 1988, 252, 199). Patatin has however been described as having specific but low activity against triglycerides with short chain fatty acids, which is advantageous for the development of cheese flavor (WO 2014/007621). However, most common plant-based lipids do not comprise such short-chain fatty acids. In fact, most plant based lipids generally comprises only fatty acids having a chain length of C8 or longer. Thus, prior to the presently formulated insights, it has not been recognized that patatin may cause hydrolysis of lipids with medium to long chain fatty acids to a significant extent.

Bakery products, in particular vegan bakery products, may be based on a dough or batter which comprises native patatin. This dough or batter in general furthermore comprises a lipid. In such products, native patatin has the function of binding the dough or foaming the batter before and during the baking process, and stabilizing the emulsion. Although during baking, the patatin denatures, the obtained bakery product still benefits from the presence of the denatured protein, as it binds the bakery product to a solid palatable food product to provide the sponge structure and elastic texture. During the preparation of the dough or batter, as well as during baking however, the presence of native patatin may cause the generation of off-flavors, a drawback which has not formerly been recognized.

Meat substitutes are another class of food products in which native patatin may be present. In such products, native patatin has the function of a gelling agent, providing the product with an appropriate solid appearance. Inherently, a meat substitute also comprises a lipid.

Two generic types of meat substitutes may be distinguished. One type of meat substitute is the ready-to-eat type, which is cooked during the production process. This type of product can be consumed as-is or after re-heating, by a final consumer.

The second type of meat substitute is the “raw-type” meat substitute. A raw-type meat substitute mimics animal-derived meat in that it has not been cooked during production. A heating step prior to consumption is necessary.

In cases where a meat substitute comprises native patatin, the native patatin may cause off-flavors, a problem which has not been recognized prior to formulation of the present insight. This problem is particularly present in raw-type meat substitutes, because in such products, the patatin remains native for a considerable time while being in contact with the lipid. However, also for ready-made products, the presence of patatin during preparation may cause off-flavors.

The present invention is based on the insight that native patatin may cause off-flavors when it is present in the presence of particular types of lipid. The invention provides mixtures comprising water, native patatin and particular types of lipid, which suppress the formation of off-flavors.

### THE INVENTION

The inventors found that the use of native patatin as a binder in lipid-containing food products results in formation of off-flavors at any time that a lipid is in contact with native patatin, and that off-flavor formation occurs faster at higher temperatures (as long as patatin does not denature).

Thus, off-flavor formation may occur during preparation, storage, and in the first stages of baking, for any food product which comprises or is prepared from native patatin. The inventors found that off-flavor formation can be prevented by preparing the food product using only particular types of lipid. This results in food products with decreased off-flavors and/or a long shelf-life, such as up to 14 days, or longer (if frozen).

The invention thus provides a method for making a food product, comprising

a) providing a mixture comprising water, native patatin and a lipid, which lipid is defined as a substance comprising fatty acid tri-esters of glycerol;

b) making the food product;

wherein the fatty acids in said lipid comprise less than 2% by mass of fatty acids having a chain length of C12 or less.

Native patatin is a protein which occurs in tubers, such as tubers of potato (Solanum tuberosum). The skilled person is aware which of the protein in a tuber can be considered patatin.

Patatin is a protein which is naturally present in the tuber as storage protein. Storage protein is protein which functions as a store for nitrogen, sulphur and/or carbon, enabling the plant to survive periods of adverse growth conditions or between growing seasons. Storage protein is generally present in a quantity of 40-50 wt. % of all protein in the tuber. Storage protein can generally be characterized by a molecular weight of 35-50 kDa, preferably 38-45 kDa and/or by an isoelectric point of 4.8-5.6. The molecular weight can be determined by commonly known methods, such as SDS page. The isoelectric point can also be determined by commonly known methods, such as for example isoelectric focusing.

In the present context, native patatin is preferably provided to the mixture in the form of a protein isolate comprising native patatin. In a preferred embodiment, the protein isolate comprising native patatin is a native tuber protein isolate, preferably a native potato protein isolate. In said native tuber protein isolate, protein is preferably present in a quantity of at least 75 wt. %, preferably at least 85 wt. %, relative to dry matter.

In preferred embodiments, the native tuber protein isolate, such as the native potato protein isolate, comprises, by wt. % of total protein, at least 35 wt. % of potato storage protein, preferably at least 40 wt. %. In embodiments where there is from 35 up to 60 wt. % of potato storage protein, relative to total protein, the tuber protein isolate can be called a total tuber protein isolate.

In further preferred embodiments, the native tuber protein isolate, such as the native potato protein isolate, comprises, by wt. % of total protein, at least 75 wt. % of potato storage protein, preferably at least 80 wt. %. In embodiments where there is 60 wt. % or more up to 85 wt. % of potato storage protein, relative to total protein, the tuber protein isolate can be called a HMW isolate comprising patatin.

In further preferred embodiments, the native tuber protein isolate, such as the native potato protein isolate, comprises, by wt. % of total protein, at least 90 wt. %, more preferably at least 95 wt. % of potato storage protein. In embodiments where there is 90 wt. % or more up to and including 100 wt. % of potato storage protein, relative to total protein, the tuber protein isolate can be called a patatin isolate. An example of a patatin isolate is Solanic 200 from Avebe.

Native patatin can be isolated from potato tubers, or from other potato-derived processing streams such as potato juice (for example the juice obtained as a side product in potato starch manufacturing), or potato cutting water (the processing water which is obtained when potatoes are being shaped for consumption as for example fries or chips). One particularly convenient method to isolate native patatin has been described in WO2008/069650, although the skilled person can obtain native patatin by other methods. In addition, native patatin is commercially available.

In further preferred embodiments, native patatin is used in the state in which it occurs in nature. That is, native patatin is preferably not modified, such as by crosslinking or complexation. As is generally known by the skilled person, native patatin is by definition a non-denatured protein; that is, native patatin is patatin which is capable of performing its natural biochemical function(s). Native patatin thus is not appreciably denatured, and has not been subjected to for example coagulation, such as heat coagulation or acid coagulation.

Native patatin can be present in the mixture at any quantity, such as from 0.1-25 wt. %, preferably 0.5-20 wt. %, more preferably 0.75-15 wt. %. Higher quantities of native patatin, as well as higher temperatures, result in higher off-flavor formation, which off-flavor formation can be suppressed or eliminated by applying a lipid as defined herein.

Water, also can be present in any quantity, such as in a quantity of 5-95 wt. %, preferably 10-90 wt. %, more preferably 15-85 wt. %. The quantity of water varies with the type of food product being prepared, as is well known in the art.

The lipid to be included in the mixture is defined as a substance comprising fatty acid tri-esters of glycerol, as is known in the art. A fatty acid tri-ester of glycerol is also known as a triacyl glyceride (TAG), or as a triglyceride. Although the term lipid may sometimes be used to include various other glycerol esters, such as phospholipids or glycolipids, the term lipid in the present context is limited to fatty acid tri-esters of glycerol, that is, molecules based on glycerol which are esterified with fatty acids on all three hydroxyl units of the glycerol moiety.

The fatty acids in said lipid comprise less than 2% by mass, preferably less than 1.5% by mass, more preferably less than 1% by mass, even more preferably less than 0.5% by mass, of fatty acids having a chain length of C12 or less.

In preferred embodiments, the fatty acids comprise less than 2% by mass, preferably less than 1.5% by mass, more preferably less than 1% by mass, even more preferably less than 0.5% by mass of fatty acids having a chain length of C14 or less.

In further preferred embodiments, the fatty acids comprise less than 30% by mass, preferably less than 25% by mass, more preferably less than 20% by mass, even more preferably less than 15% by mass of fatty acids having a chain length of C16 or less.

In further preferred embodiments, the lipid is a substance wherein at least 92% by mass, preferably at least 94% by mass, more preferably at least 96% by mass of the fatty acids are fatty acids having a chain length of C16 or higher.

In further preferred embodiments, the lipid is a substance wherein the total of C10-C16 fatty acids is less than 35% by mass, preferably less than 25% by mass, even more preferably 18% by mass, relative to the total fatty acids.

Native patatin, has been found to have at least some activity on some lipids comprising fatty acids with a chain length of C10 or higher, at least to a sufficient extent to cause off-flavors. This activity is also present on some lipids comprising fatty acids with a chain length of C12 or higher, and even on some lipids comprising fatty acids with a chain length of C14 or higher. Even lipids comprising fatty acids with a chain length of C16 or higher can be hydrolyzed by patatin to a degree which is sufficient to cause off-flavors.

It is thus an insight underlying the invention that patatin exerts activity on triglycerides with chain lengths of from C8 to C16, to such an extent that this activity causes off-flavors.

The action of patatin may be hydrolytic, but may also be another, yet unknown enzymatic activity of patatin, which activity is suppressed by applying a lipid as defined in claim 1 and elsewhere. The exact mechanism behind off-flavor formation in food products comprising native patatin but using a different lipid than in claim 1 is at present not understood. The examples show however that formulating a food product in line with the present invention suppresses off-flavor formation.

Off-flavors in the present context are defined as a lingering bitter sensation upon ingestion, which is accompanied by a stingy smell that can be described as “paint” or “vomit”. The lipids recited in claim 1 and elsewhere can be used to avoid off-flavor formation.

Off-flavor can preferably be determined by sensory evaluation. Off flavor can also be determined in model systems by measuring the release of free fatty acids and/or by measuring the para-anisidine value. In such cases, off-flavor can be defined as not present provided that the pAV of the lipid is maintained at 2 or less, preferably 1.5 or less, even more preferably 1 or less, and/or provided that the release of free fatty acids from the lipid is less than 50 mmol/kg oil, preferably less than 40 mmol./kg oil.

Much preferred lipids are plant-based lipids, such as a seed oil, nut oil, or fruit oil. Mixtures of different lipids may also be used. Particularly preferred lipids comprise one or more of the lipids in the group of corn oil, soybean oil, rapeseed oil, sunflower oil, grape seed oil, peanut oil, sesame oil, olive oil, shea butter, cocoa butter, and rice bran oil. In optional embodiments, the lipid may be partially hydrogenated.

The lipid may colloquially be referred to as a fat or an oil. An oil in the present context is a lipid which is liquid or viscous at 20° C. (under atmospheric pressure). Liquid or viscous is a term which reflects the capability to flow under the influence of gravity.

Fat in the present context is a lipid which is solid at room temperature (20° C.) (under atmospheric pressure). Solid in this context is defined as the capability to maintain a particular shape for at least 24 hours in the absence of support. If pressure is applied above atmospheric pressure, a solid lipid may change shape, which changed shape can be maintained for at least 24 hours after the pressure has been applied, without support.

The lipid to be provided to the mixture is preferably as pure as possible. That is, the quantity of free fatty acids (“FFA”) in the lipid is preferably less than 18 mmol per kg lipid, more preferably less than 9 mmol per kg lipid, even more preferably less than 3 mmol per kg lipid. The quantity of free fatty acids in the lipid can be determined by a chemical titration method, as described below. The quantity of free fatty acids can also be determined by HPLC, as is generally known in the art.

Additionally or alternatively, the total quantity of diacylglycerols (“DAG”) and monoacylglycerols (“MAG”) in the lipid to be provided to the mixture is preferably less than 10 wt. %, more preferably less than 6 wt. %, even more preferably less than 4 wt. %, relative to the total lipid. The quantity of DAG and MAG in the lipid can be determined by column chromatography or capillary gas chromatography as described in “Standard Methods for the Analysis of Oils, Fats and Derivatives”, 1^{st} supplement to the 7^{th} edition (IUPAC, 1987).

Food products which may be made using the present invention include any food product which comprises, or has been prepared from, a mixture comprising water, native patatin and a lipid as elsewhere defined.

In the present context, two types of food product may be distinguished, on the basis of the mechanisms by which off-flavors develop: food products which develop off-flavors due to a prolonged period in which native patatin is in contact with the lipid (“cold storage” type food product), and food products which develop off-flavors due to a brief heat shock in which native patatin is in contact with the lipid (“heat shock” type food products).

In cold storage type food products, the prolonged period in which native patatin is in contact with the lipid is generally a storage period, preferably cold storage. Storage includes any prolonged period in which no active steps are taken on the food product. Storage thus means that the food product is left to stand, for any reason, including one or more of storage prior to sale or transport, a period of gelation, or a period of ripening, maturing or fermenting.

Cold storage type food products are food products where making the food product comprises a step of cooling to a temperature of from −35° C. to 20° C. In preferred embodiments, a cold storage type food product has not been heated to a temperature above 60° C. prior to cooling.

Cold storage type food products are food products comprising water, patatin and a lipid, in which the native patatin is in contact with the lipid during a period of storage, wherein during the period of storage, the patatin is native, thereby having the potential to cause off-flavor formation, which off-flavor formation is suppressed by selecting a lipid according to the present invention.

In preferred cold storage type food products, the native patatin is present as a gelling agent in the mixture. In such cases, the temperature during storage is preferably 0-20° C., more preferably 0° C. to 10° C., even more preferably 0-5° C.

Examples of cold storage type food products are a meat substitute, batter, dough, cheese, cream cheese, butter, yoghurt, sauce, dressing, and cream, most preferably a plant-based (vegan) batter, dough, cheese, cream cheese, butter, yoghurt, sauce, dressing, or cream.

Heat shock type food products are food products where making the food product comprises a step of heating the food product to a temperature of at least 75° C., preferably at least 125° C., more preferably at least 150° C. for a period of at least 1 minute, preferably at least 15 minutes. Heat shock type food products are food products which are prepared from a mixture of water, native patatin and a lipid, in which the native patatin is in contact with the lipid, and in which the rise in temperature during heating causes off-flavor formation prior to denaturation and concomitant inactivation of the patatin.

Examples of heat shock type food products are generally bakery products, such as a muffin, cookie, cake, pie, macaron, sponge cake or waffle. A further preferred heat shock type food product is a fried snack (a product with a crust and an inner filling, which is generally prepared by heating to a temperature of 150-200° C. in fat or oil), such as a croquette, nugget, fish finger or lumpia, most preferably a plant-based (vegan) fried snack.

These two type of food products are not necessarily mutually exclusive: in some food products, both mechanisms for off-flavor formation are relevant. A dough which is ripened for a few hours to a few days at room temperature may be subsequently baked. In this case, the baked dough may suffer off-flavor formation by both mechanisms, if the lipid used was not a lipid according to the invention. Also, a meat substitute is stored cold for a prolonged period prior to being heated for cooking, so that also for a meat substitute, both mechanisms of off-flavor formation apply. A bakery product and a meat substitute are therefore much preferred embodiments of the invention.

Generally however, cold storage type food products can be distinguished from heat shock type food products, by identification of the main mechanism responsible for off-flavor formation in the food product, in cases where no lipid of the invention is applied.

Thus, a meat substitute is considered a cold storage type food product, because off-flavor formation occurs mostly during the period of cold storage, and the brief cooking/baking period contributes relatively little off-flavors. Bakery products such as muffins on the other hand, are considered heat-shock type food products, because there is relatively little off-flavor formation during the brief period of batter preparation prior to baking, and off-flavor formation occurs more readily during the baking period.

In preferred embodiments, a food product of the invention is a vegetarian or vegan food product, preferably a vegan food product. This has the advantage that the lipids introduced during the making of the food product can be controlled. This is because during the making of a vegan food product, lipids are generally introduced in the form of an isolated and/or purified plant-based lipid, which generally has a well-known composition. For food products comprising meat, fish or crustaceans, the meat, fish or crustacean contributes lipids, the composition of which may be less known, and/or contribute lipids not according to the invention.

Food products of the invention can be made by methods generally known for the making of the type of food product in question. Reference is made to common general knowledge on the making of any individual food product described herein.

Making the food product preferably comprises one or more of the steps of shaping, mixing, cooling, heating, fermentation, combination with further ingredients and/or a period of storage, preferably cold storage at a temperature of less than 15° C., preferably less than 10° C. This is generally known in the art.

### Meat Substitutes

In one embodiment, the invention provides a method for making a meat substitute, comprising

a) providing a mixture comprising water, a denatured plant protein, native patatin and a lipid, which lipid is defined as a substance comprising fatty acid tri-esters of glycerol;

b) shaping the meat substitute; and

c) cooling the meat substitute to a temperature of from −35° C. to 20° C.;

wherein the fatty acids in said lipid comprise less than 2% by mass of fatty acids having a chain length of C12 or less. Reference is made to the further description of the lipid which may be used in the present invention, above.

A meat substitute, in the present context, is a product which resembles animal-derived meat, but which is prepared using mainly plant-based ingredients. A meat substitute is thus suitable for vegetarians, and may depending on the actual ingredients used, also be suitable for a vegan lifestyle.

A vegetarian meat substitute is a meat substitute which does not include meat derived from a mammal or a bird, but which may include meat derived from a fish or a crustacean such as shrimp or shellfish, and which may furthermore include non-meat animal derived products (products which do not require scarification of animals), such as milk, cream or egg. In preferred embodiments, a vegetarian meat substitute comprises no meat which has been derived from a mammal, bird, fish or crustacean, but which may comprise non-meat animal-derived products such as milk, cream or egg.

A vegan meat substitute is a meat substitute which does not include any animal-derived products. A vegan meat substitute comprises only plant-based ingredients.

Preferably, the meat substitute is a non-meat analogue of a burger, meatball, sausage, minced meat, schnitzel, skewer, nugget, rib, filet or meat chunk.

In order to obtain the meat substitute of the invention, first, a mixture is provided comprising water, a denatured protein, native patatin and a lipid. Preferably, the mixture comprises at least 20 wt. % of water, more preferably 30-85 wt. %, even more preferably 48-65 wt. %, even more preferably 51-61 wt. %, relative to the total weight of the mixture.

The denatured protein can be any non-meat protein, including (for certain vegetarian products) fish or crustacean derived protein. Preferably however, the denatured protein is a denatured plant protein. Denatured protein is preferably present at a quantity of 3-35 wt. %, preferably 10-30 wt. %, more preferably 15-26 wt. %, even more preferably 18-24 wt. %, relative to the total weight of the mixture.

The denatured plant protein is preferably a protein derived from a tuber, cereal, nut or legume. In particularly preferred embodiments, the protein is selected from the group consisting of soy protein, pea protein, wheat protein/gluten, potato protein, faba bean protein, mungbean protein, hemp seed protein, mushroom protein, sesame seed protein, sweet potato protein, chick pea protein, lentil protein, oat protein and spelt protein, most preferably soy protein or pea protein. The denatured plant protein is preferably a coagulated protein, such as a protein obtained by acid or heat coagulation. The skilled person can obtain denatured plant protein by generally known methods.

In much preferred embodiments, the denatured plant protein is a texturized plant protein. Texturized plant protein is well-known, and commercially available. Texturized plant protein is a plant-based protein which has been subjected to a step of extrusion, which provides the protein with a meat-like fibrous structure. In much preferred embodiments, the texturized plant protein is a texturized pea protein, a texturized soy protein, a texturized potato protein or a texturized gluten.

Native patatin is preferably present in the mixture in a quantity of 1-15 wt. %, preferably 2-10 wt. %, more preferably 2.5-7.5 wt. %, relative to the total weight of the mixture.

In preferred embodiments, native patatin is the sole native protein in the mixture, and in the final meat substitute. This has the advantage of providing good binding strength. In the present context, patatin being the sole native protein means that the mixture comprises 60 wt. % or more, preferably at least 90 wt. % or more, of potato storage protein, relative to all native protein. Thus, embodiments in which patatin is provided as a HMW isolate comprising patatin or, preferably, as a patatin isolate, are considered embodiments in which native patatin is present as the sole native protein. In particular the mixture preferably does not comprise native protease inhibitors.

Lipids as herein defined have been found to result in the advantage that the meat substitute does not develop off-flavor upon storage in the period between production and consumption. In addition, lipids as herein defined have been found to suppress off-flavor formation during heating of the meat substitute prior to consumption.

The lipid is preferably present in a quantity of 3-25 wt. %, preferably 5-18 wt. %, more preferably 8-15 wt. %, relative to the total weight of the mixture.

Preferably, in a meat substitute, the lipid is a fat or oil which has a melting point which is higher—30° C., more preferably higher than—20° C., even more preferably higher than −10° C., even more preferably higher than −5° C. The melting point of suitable lipids in the present context is generally known from for example text books, but may also be determined experimentally by heating the lipid slowly, and determining the temperature at which the lipid melts.

In preferred embodiments, the lipid of the invention is a lipid which is solid at temperatures in the range of from −35° C. to 20° C., preferably of from −18 to 15° C., more preferably of from 0° C. to 10° C. Preferably, in this embodiment, the lipid has a melting point which is higher than 20° C., more preferably higher than 25° C., even more preferably higher than 30° C. Using a lipid which is solid at room temperature has the advantage that the meat substitute can be provided with a meat-like appearance, and that shape of the meat substitute is maintained better.

In order to not affect bite and mouthfeel negatively, the lipid preferably has a melting point which is below 60° C., preferably below 50° C., more preferably below 45° C., even more preferably below 40° C.

Thus, the melting point of a lipid which is solid in the temperature range of from −35° C. to 20° C. is preferably in the range of 20-60° C., more preferably 25-50° C., even more preferably 30-45° C., and most preferably 30-40° C. The mixture may generally be prepared by any conventional means, and may be prepared by mixing the ingredients in any order. In preferred embodiments, the denatured protein is mixed with part of the lipid, whereupon a second part of the lipid is added to obtain a homogenous mass which can be shaped by applying gentle pressure.

When the denatured protein is a texturized plant protein, it is preferred that the texturized protein is hydrated prior to providing the mixture. In such embodiments, the texturized plant protein is first mixed with water to effect hydration, and subsequently mixed with any other ingredients, as well as the lipid, or part of the lipid, as specified above. The mixture is preferably a homogenous mixture of the various ingredients.

In preferred embodiments, the mixture may additionally include various other ingredients, in order to enhance taste, appearance, texture, mouthfeel and the like. Preferably, the mixture includes one or more salts, such as salts selected from the group consisting of sodium, potassium or calcium chloride, sodium or potassium glutamate and calcium sulfate. Salts may be present in a quantity of for example 0.1-5 wt. %, preferably 0.5-2.5 wt. %, relative to the total weight of the mixture. In much preferred embodiments, the mixture comprises 0.1-3 wt. % sodium chloride, preferably 0.5-2 wt. %, relative to the total weight of the mixture.

Also, the mixture may include pigments, such as heme-like pigment, red beet pigment, carotene, caramel, beet juice extract, tomato pigment, radish pigment, paprika pigment and amaranth. The quantity of pigment varies with the type of pigment used, and can be determined by routine experiments.

In preferred embodiments, the mixture furthermore includes one or more fibers, in particular dietary fibers, such as selected from the group consisting of potato fiber, sweet potato fiber, carrot fiber, psyllium fiber, bamboo fiber, soybean fiber, pea fiber, mungbean fiber, tapioca fiber, coconut fiber, banana fiber, cellulose, resistant starch, resistant dextrins, inulin, lignin, chitin, pectin, beta-glucan, and oligosaccharide. The quantity of fiber can be 0.1-10 wt. %, preferably 0.5-7.5 wt. %, more preferably 1-5 wt. %, relative to the total weight of the mixture.

Also, texturisers such as native starch, modified starch, cellulose derivatives, carrageenan, alginate, agar, konjac, xanthan, and pectin may be included in the mixture, preferably at a quantity of 1-10 wt. %, preferably 1.5-5 wt. %, relative to the total weight of the mixture.

Furthermore preferred is to include flavor development aids, such Maillard-active ingredients, among which for example dextrose, ribose and maltodextrin. Flavor development aids can be present in a quantity of 0.1-5 wt. %, preferably 0.2-2 wt. %, relative to the total weight of the mixture.

Also other flavorings can be present in the mixture, such as for example a sweetener selected from the group consisting of sucrose, glucose, fructose, syrup, and artificial sweeteners.

In preferred embodiments, the mixture, or the resulting meat substitute, does not comprise a hydrocolloid, such as alginate, agar, konjac, xanthan, pectin or carrageenan. In further preferred embodiments, the mixture, or the resulting meat substitute, does not comprise a gelling non-starch carbohydrate, such as such as cellulose derivatives, in particular methylcellulose or carboxy methyl cellulose. In further preferred embodiments, the mixture, or the resulting meat substitute, does not comprise a modified starch.

The ingredients of the mixture native patatin, lipid and protein can be present in various weight ratios. The weight ratio native patatin:lipid is preferably 1: 1-1:5, more preferably 1: 1-1:3. The weight ratio lipid:denatured protein is preferably 1: 1-1:5, more preferably 1: 1-1:3. The weight ratio patatin:protein is preferably 1: 1-1:10, more preferably 1: 2-1:6. The weight ratio patatin:lipid:protein is thus preferably in the order of 1:(1-3):(2-6), preferably 1:(1.5-2.5):(3-4). The remainder of the mixture is water and optional further ingredients, as outlined elsewhere.

The mixture described above is subsequently shaped into a desired shape. The shape is determined by the type of meat substitute. Any shape can be used, although in order to attract consumer preference, the chosen shape is preferably customary for the type of meat substitute in question. For example, a burger may be shaped in round disk-like shape, a sausage may be provided with a cylindrical shape, and a meat ball with a globular shape.

Shaping can be achieved by any conventional means. Preferably however, shaping is achieved by introducing the mixture into a mold of the chosen shape. Preferably, the mixture is introduced into the chosen mold, and subsequently pressed to attain a dense structure similar to animal-derived meat.

The mixture is subsequently cooled to a temperature of from −35° C. to 20° C., preferably of from −18 to 15° C., more preferably of from 0° C. to 10° C., more preferably 0-5° C. Cooling results in gelation of the native patatin, and thus has the effect that the shape of the meat substitute can be maintained also without the mold. Cooling may be achieved by any conventional means. Refrigeration is preferred. If cooling is performed to a temperature below 0° C., it is preferred that cooling is performed in two steps: first to a temperature of 0-20° C. to effect gelation of the patatin, and subsequently to a lower temperature.

In much preferred embodiments, the method of the invention results in a raw-type meat substitute. In this embodiment, the meat substitute is not heated to a temperature above 60° C. prior to cooling. Instead, the meat substitute is cooled and generally maintained at the temperature of from −35° C. to 20° C., preferably of from −18 to 15° C., more preferably of from 0° C. to 10° C., more preferably 0-5° C., throughout the period until cooking the meat substitute. This period is the period between the production of the meat substitute and its consumption. In this period, the meat substitute is transported from the production location, to various retail shops, to the end consumer. This period is preferably 1-14 days. This is in particular true in embodiments where cooling is generally maintained at temperatures between 0° C. to 15° C.

In embodiments where cooling is maintained at temperatures below 0° C. for a longer time, the period until cooking may be prolonged by the time during which the temperature was below 0° C. The time during which the temperature is maintained below 0° C. is called the freezing time, and the freezing time may be any time, such as of from one day to three years, preferably one week to one year.

Only when the meat substitute arrives at the end consumer, the burger is cooked, such as at a temperature of at least 75° C. for a period of at least 1 minute.

In case the method is performed to obtain a ready-to-eat type meat substitute, the burger is cooked after shaping. Cooking in this case means heating to a temperature of at least 75° C. for a period of at least 1 minute.

The invention furthermore provides a meat substitute, comprising water, native patatin, a denatured protein and a lipid, which lipid is defined as a substance comprising fatty acid tri-esters of glycerol, wherein the fatty acids in said lipid comprise less than 2% by mass of fatty acids having a chain length of C12 or less. Preferably, the fatty acids in the lipid comprise less than 2% by mass of fatty acids having a chain length of C14 or less. Further preferably, the fatty acids in the lipid comprise less than 30% by mass of fatty acids having a chain length of C16 or less.

The meat substitute comprises the ingredients water, native patatin, a denatured protein and a lipid. These ingredients have been described above, but the described features and definitions in the context of the method equally pertain to the meat substitute of the invention. The above description of providing the mixture allows to infer the composition of the final meat substitute, as the quantities and character of all the different ingredients are not affected by the preparation method, at least not prior to heating, when the patatin denatures.

Thus, summarizing the above without repeating all details, at least 92% by mass of the fatty acids in the lipid are fatty acids having a chain length of C16 or higher. Much preferred lipids are lipids in which less than 30% by mass of the fatty acids are fatty acids having a chain length of C10-C16. The lipid in the meat substitute preferably comprises one or more of the lipids in the group of corn oil, soybean oil, rapeseed oil, sunflower oil, grape seed oil, peanut oil, sesame oil, olive oil, shea butter, cocoa butter, and rice bran oil, which lipids may optionally have been hydrogenated.

The denatured plant protein is preferably a protein derived a tuber, cereal, nut or legume. In particularly preferred embodiments, the protein is selected from the group consisting of soy protein, pea protein, wheat protein/gluten, potato protein, faba bean protein, mungbean protein, hemp seed protein, mushroom protein, sesame seed protein, sweet potato protein, chick pea protein, lentil protein, oat protein and spelt protein, most preferably soy protein or pea protein. Preferably, the protein is a texturized plant protein.

The meat substitute comprises less than 18 mmol per kg lipid of free fatty acids and alternatively or additionally have a total of diacylglycerols and monoacylglycerols, relative to the total lipid, of less than 10 wt. %.

The meat substitute may furthermore comprise various optional ingredients, such as one or more salts, such as a salt selected from the group consisting of sodium, potassium or calcium chloride, sodium or potassium glutamate and calcium sulfate, and/or one or more pigments, such as a pigment selected from the group consisting of heme-like pigment, red beet pigment, carotene, caramel, beet juice extract, tomato pigment, radish pigment, paprika pigment and amaranth, and/or one or more fibers, such as a fiber selected from the group consisting of potato fiber, sweet potato fiber, carrot fiber, psyllium fiber, bamboo fiber, soybean fiber, pea fiber, mungbean fiber, tapioca fiber, coconut fiber, banana fiber, cellulose, resistant starch, resistant dextrins, inulin, lignin, chitin, pectin, beta-glucan, and oligosaccharide, and/or one or more texturizers such as a texturizer selected from the group consisting of native starch, modified starch, cellulose derivatives, carrageenan, alginate, agar, konjac, xanthan, and pectin, and/or one or more flavor development aids selected from the group consisting of dextrose, ribose and maltodextrin, and/or one or more flavorings, such as a sweetener selected from the group consisting of sucrose, glucose, fructose, syrup, and artificial sweeteners.

The meat substitute of the invention preferably comprises patatin as the sole native protein. That is, the meat substitute preferably does not comprise other types of native protein than patatin, such as for example potato-derived protease inhibitor, or other types of native protein.

### Bakery Products

In another embodiment, the food product is a bakery product. In this embodiment, the method preferably comprises a step of heating the food product to a temperature of at least 75° C., preferably at least 125° C., more preferably at least 150° C. for a period of at least 1 minute, preferably at least 15 minutes. In methods according to the invention in which the food product is a bakery product, the method comprises

a) providing a mixture comprising water, flour, native patatin and the lipid;

b) homogenizing and optionally ripening the mixture; and

c) heating the mixture to a temperature of at least 125° C. for a period of at least 15 minutes.

The mixture may comprise water in quantities suitable for the type of bakery product in question. Reference is made to common general knowledge on the preparation of bakery products. If the bakery product is prepared from a batter, the mixture is generally liquid to viscous, and comprises water in a quantity of from 10-40 wt. %, preferably 15-35 wt. %, more preferably 20-30 wt. %. If the bakery product is prepared from a dough, the mixture generally comprises less water, such as from 5-30 wt. %, preferably 10-25 wt. %.

The mixture for making a baking product furthermore comprises flour. Flour can be any type of flour suitable for making the bakery product in question, which is known in the art. Preferred types of flour are wheat flour, maize flour, tapioca flour, soy flour, rice flour, bean flour, pea flour, potato flour, oat flour, millet flour, sorghum flour, preferably wheat flour or maize flour. Flour suitable for making bakery products is commercially available.

The mixture for preparing a bakery product furthermore comprises native patatin. Native patatin suitable for this context has been defined elsewhere. In the making of bakery products as herein defined, patatin denatures during the heating step. Off-flavors however develop during the heating step prior to patatin denaturation, and the invention provides mixtures which suppress this off-flavor formation.

The mixture for preparing a bakery product furthermore comprises a lipid. The lipid, also, has been defined elsewhere. Providing the said lipid to the mixture suppresses off-flavor formation during the heating step.

The mixture for preparing a bakery product furthermore may comprise additional ingredients conventional for the type of bakery product in question. Reference is made to common general knowledge on the making of bakery products.

In preferred embodiments, the mixture may comprise sugar. If sugar is present, sugar may be present in a quantity of from 5-35 wt. %, preferably 10-30 wt. %, more preferably 15-25 wt. %.

In further preferred embodiments, the mixture may comprise yeast. Yeast is particularly suitable in the making of bakery products from a dough, which has preferably been ripened.

In other preferred embodiments, the mixture may comprise a leavening agent. Appropriate leavening agents, and appropriate quantities of use, are generally known in the art. A preferred leavening agent is sodium bicarbonate, which may be present in the mixture a quantity of from 0.1-2 wt. %.

Further conventional ingredients can be salt, such as sodium chloride and/or potassium chloride, which may be present in a quantity of from 0.1-2 wt. %.

Furthermore, the mixture may comprise various known flavorings and additives, as is known in the art. Examples of flavorings include cocoa, vanilla extract, a sweetener, or various fruit, vegetable or meat-like flavorings. Additives may include emulsifiers, stabilizers and/or colorants, as is generally known.

In addition, conventional ingredients may include food items, such as solid food items, among which partitioned or whole fruit, for example partitioned apple pieces, whole or crushed berries or raisins, or partitioned meat, vegetables, chocolate, cheese and the like, as is known in the art. Liquid or viscous food items can also be used, such as milk, butter or cream. Inclusion of food items is particularly preferred in the making of bakery products such as pie, cookies or muffins.

The mixture is subsequently homogenized and optionally ripened, in line with conventional knowledge on the making of bakery products. Homogenization may include mixing, aeration, kneading, whipping, and may be done for any time needed to prepare a suitable dough or batter, such as from 1 minute to 30 minutes.

Ripening may include a period of standing, such as at a temperature of from 0-40° C., preferably 2-36° C. The period may be for example 30 minutes to 300 minutes, as is known in the art.

The step of ripening is preferred for example in cases where the mixture comprises yeast, in which case the temperature during ripening is preferably 20-40° C., more preferably 25-36° C.

The step of ripening is furthermore preferred in cases where the mixture is to gain increased viscosity, such as in cases where the native patatin is present as a gelling agent. In such cases, the temperature during ripening is preferably 0-20° C., more preferably 0° C. to 10° C., even more preferably 0-5° C.

The homogenized and optionally ripened mixture is subsequently baked in order to obtain the bakery product. Baking is achieved by a heating step appropriate for the type of bakery product in question, as is known in the art. Heating is to a temperature of at least 125° C., preferably at least 150° C. more preferably at least 175° C., for a period of at least 15 minutes.

During the heating step, the mixture undergoes several changes conventional in the making of bakery products, and the patatin denatures. Denaturation of patatin occurs at a rate which is slower than the heating of the surface temperature of the bakery product, as the core temperature of the mixture during baking only gradually rises. Generally, the core temperature of the bakery product does not rise above 100° C. during the baking period, so that patatin remains at least partially native to a sufficient extent to result in off-flavor formation, during the majority of the baking period. This off-flavor formation is avoided by selecting a lipid according to the invention.

In much preferred embodiments, the mixture does not comprise animal-derived ingredients. In such embodiments, the bakery product is a vegan bakery product, comprising only one or more plant-based lipids. Animal-derived ingredients include for example milk, cream and egg, as is known in the art.

One particularly preferred type of bakery product is a muffin. In this embodiment, the mixture is a batter, which batter may comprise of from 10-40 wt. % water, preferably 15-35 wt. %, more preferably 20-30 wt. %. The mixture furthermore comprises flour, preferably wheat flour, in a quantity of from 15-35 wt. %, preferably 20-30 wt. %. The lipid in mixture for making a muffin is present in a quantity of from 15-35 wt. %, preferably 20-30 wt. %.

Bakery products, among which muffins, obtained by the present method include the ingredients listed above for the method, generally in the outlined proportions. However, the mixture is altered by the heating step by various ways in line with common general knowledge, including denaturation of patatin, gelation of flour, decomposition of sodium bicarbonate, and others, resulting in a food product of the invention, obtainable by the methods described above.

For the purpose of clarity and a concise description features are described herein as part of the same or separate embodiments, however, it will be appreciated that the scope of the invention may include embodiments having combinations of all or some of the features described.

### EXAMPLES

### Chemicals

The patatin used is commercially available (Solanic 200®, Avebe). Potato fiber was Paselli FP from Avebe.

Lipids which are solid at room temperature were 100% pure coconut oil (KTC); 100% red palm oil (Aman Prana); hydrogenated rapeseed oil; commercial vegetable oil A; commercial vegetable oil B, commercial oil palm stearin flakes and commercial shea butter.

Lipids which are liquid or viscous at 20° C. were sunflower oil (Reddy); Olio di Sansa di Oliva (olive oil, Kalliston); corn oil (Olitalia); soybean oil (Levo); grapeseed oil (Saveurs de Lapalisse); rapeseed oil (Your Organic Nature); 100% pure sesame oil (Chee Seng); peanut oil (Heuschen & Schrouff) and rice oil (Alesie).

Texturized vegetable protein in the experiments was texturized soy protein: Soprotex N (Barentz).

### Equipment for Emulsification

When the experiments denote “emulsification”, a T18 Ultraturrax with T18N (10 or 19 g) disperging tool or a T25 Ultraturrax with T25N (8 g) disperging tool from IKA were used. Results with the two types of equipment are identical. In addition, an Analog vortex mixer from VWR was used, and a Multifuge 1S-R or X3R benchtop centrifuge from Thermo Scientific. For weighing, a BP3100 S balance from Satorius was used.

Incubation of Patatin with Lipids and Extraction of the Lipid

A patatin solution was prepared of 3.3% in demineralized water. Solid lipids were melted at 50 or 60° C. except for palm stearin flakes, which were used in solid form. The lipid was added in a 1:1 (w/w) ratio to the patatin solution or to demineralized water, which served as a control. The solutions were mixed by turrax for 1 minute at about 10.000 rpm, except for palm stearin flakes. Then, the solutions were left at room temperature overnight under gently shaking so that release of fatty acids and fat oxidation could occur.

Subsequently hexane was added in a quantity of about 5 ml per 2-gram solution, and the sample was vortexed several times in a time frame of 30 minutes to extract the lipids from the aqueous phase. Subsequently, the layers were separated by centrifugation (5 minutes, 4700 rpm, swing-out). The hexane layer (top layer) was used for determination of free fatty acids and/or pAV. The protocol above was followed unless indicated otherwise.

### Determination of Free Fatty Acid Formation

Patatin cleaves the ester linkage between a fatty acid and the glycerol core, producing free fatty acids. Titrimetry was used to determine the free fatty acid content of mixtures of patatin and a lipid after hexane extraction. The method is based on chemical titration method published by the Cyberlipid Center (Leray).

A solvent mixture (ethanol/tert-Butyl methyl ether, 1/1, v/v) was prepared and 10 ml phenolphthalein solution was added. As titrant a 10 mM KOH in ethanol solution was prepared. The hexane layer of the oil phase was transferred by a glass pipet to a 100 ml Erlenmeyer with cap. Solvent mixture was added to obtain approximately 30-50 ml solution. Titrant was added while stirring the solution on a magnetic stirrer to the end point of the indicator (light purple colour persisting for few seconds). The amount of titrant added was determined by weighting the Erlenmeyer before and after titrant addition. The weight was used to calculate the mmol alkaline/kg of oil was used. The value was corrected for the blank.

$$Equation = \frac{{m}_{titrant} * {M}_{titrant}}{{m}_{oil}} * 1000 = m mol KOH / kg oil$$

in which mₜᵢₜᵣₐₙₜ is mass of titrant added to sample in g, Mₜᵢₜᵣₐₙₜ is the molar mass in mmol KOH/g titrant and mₒᵢₗ is the mass of oil in the sample in g.

Determination of para-anisidine value (pAV) of lipids Secondary oxidation products were determined by measuring the para-Anisidine value (pAV) according to the method of the American Oil Chemists Society (AOCS, 2004, Official method Cd. 18-90 in: Official methods and recommended practices of the American Oil Chemists Society). This method detects fatty aldehydes, in particular unsaturated ones. The p-anisidine value is defined as 100 times the optical density measured at 350 nm in a 1 cm cuvette of a solution containing 1.00 g of the oil in 100 mL of a mixture of solvent and para-anisidine reagent (20 mM para-anisidine, SigmaAldrich A88255).

### Determination of Fatty Acid Composition by Gas Chromatography

The fatty acid composition of a lipid was determined by GC, on the basis of full lipid hydrolysis and conversion of the fatty acids to methyl esters.

A lipid sample of about 5 mg was weighed in a 20 ml glass tube, to which there was added 2 ml methanol containing 50M NaOH. The tube was closed, and incubated for 30 min at 70° C. in a block heater. After cooling to room temperature, 3 ml 20% BF₃ reagent in MeOH was added to the tube, effecting methylation of the fatty acids to obtain fatty acid methyl esters (FAME's).

The samples were cooled to room temperature, whereupon 5 ml saturated aqueous NaCl and 2.5 ml n-hexane was added. The tube was closed and vortexed for 1 min and mixed for 15 min with a test tube rotator. From the top hexane layer, there was taken 2 ml, which was transferred to the GC.

| Column | Stabil Wax-Da, 30 m × 0.32 mm, 0.25 μm | |
|---|---|---|
| Oven | 50° C. for 2 min, ramp 16° C./min to 250° C. | |
| | and hold 13 min isotherm at 250° C. | |
| injector | PTV 250° C., flow: 1.2 ml/min, splitless flow: | |
| | 50 ml/min, splitless time: 0.8 min | |
| Run Time | Total run time is 30 min. | |
| Injection volume | 1 μl | |
| MS | Fullsean (TIC) = 30-450 amu, dwell/sean time: | |
| | 0.2 sec | |
| Retention time FAME'S | FA_C12:0 10.63 | FA_C18:3 15.32 |
| (FA) (minute) | FA_C14:0 12.03 | FA_C20:0 15.70 |
| | FA_C16:0 13.29 | FA_C20:1 15.90 |
| | FA_C18:0 14.46 | FA_C22:0 17.39 |
| | FA_C18:1 14.63 | FA_C22:1 17.69 |
| | FA_C18:2 14.91 | FA_C24:0 19.90 |

### Example 1: Determination of the Fatty Acid Composition of Various Lipids

Lipids were purchased as indicated. The fatty acid composition of the lipids was determined following the protocol described above. The results are shown in table 1.

TABLE 1
fatty acid composition of various lipids.

| | oil | | | | | | | | |
|---|---|---|---|---|---|---|---|---|---|
| | | Palm | Red | Palm | Rice | | Soy | Grape- | |
| | Coconut | kernal | palm | stearin | oil | Corn | bean | seed | Sesam |
| | % | % | % | % | % | % | % | % | % |
| FA | (m/m) | (m/m) | (m/m) | (m/m) | (m/m) | (m/m) | (m/m) | (m/m) | (m/m) |
| C4:0 | ND | ND | ND | ND | ND | ND | ND | ND | ND |
| C6:0 | ND | ND | ND | ND | ND | ND | ND | ND | ND |
| C8:0 | 12.5 | 5.0 | ND | ND | ND | ND | ND | ND | ND |
| C10:0 | 10.5 | 48.0 | ND | ND | ND | ND | ND | ND | ND |
| C12:0 | 29.7 | 16.0 | 1.3 | ND | 0.9 | ND | ND | ND | ND |
| C14:0 | 16.7 | 8.0 | 3.6 | 4.1 | 0.9 | ND | ND | ND | ND |
| C16:0 | 10.4 | 2.0 | 35.8 | 39.6 | 19.4 | 16.9 | 15.0 | 12.8 | 14.0 |
| C18:0 | 5.0 | 15.0 | 8.5 | 13.4 | 4.9 | 4.6 | 6.6 | 9.2 | 11.8 |
| C18:1 | 9.1 | ND | 32.5 | 26.0 | 32.9 | 31.2 | 24.7 | 24.2 | 33.8 |
| C18:2 | 3.7 | ND | 14.0 | 11.0 | 26.9 | 40.1 | 37.4 | 48.7 | 32.3 |
| C18:3 | ND | ND | ND | ND | 2.9 | 2.6 | 11.3 | 1.1 | 1.3 |
| C20:0 | ND | ND | 0.8 | 1.2 | 2.5 | 1.1 | ND | 0.6 | 2.3 |
| C20:1 | ND | ND | ND | ND | 2.3 | 1.0 | ND | 0.9 | 0.9 |
| C22:0 | ND | ND | ND | ND | ND | ND | ND | ND | ND |
| C22:1 | ND | ND | ND | ND | ND | ND | ND | ND | ND |
| C24:0 | ND | ND | ND | ND | 1.1 | ND | ND | ND | ND |
| Rest FA | 2.5 | 6.0 | 3.5 | 4.7 | 5.5 | 2.5 | 5.1 | 2.6 | 3.7 |
| tot ≤ C12 | 52.6 | 69.0 | 1.3 | 0.0 | 0.9 | 0.0 | 0.0 | 0.0 | 0.0 |
| tot ≤ C14 | 69.4 | 77.0 | 5.0 | 4.1 | 1.8 | 0.0 | 0.0 | 0.0 | 0.0 |
| tot ≤ C16 | 79.7 | 79.0 | 40.8 | 43.7 | 21.2 | 16.9 | 15.0 | 12.8 | 14.0 |
| tot ≥ C16 | 28.2 | 17.0 | 91.6 | 91.2 | 92.9 | 97.5 | 95.0 | 97.5 | 96.4 |
| tot C10-C16 | 67.3 | 74.0 | 40.8 | 43.7 | 21.2 | 16.9 | 15.0 | 12.8 | 14.0 |

| | oil | | | | | | |
|---|---|---|---|---|---|---|---|
| | | Rape- | | | shea | Veg | Veg |
| | Peanut | seed | Sunflower | Olive | butter | oil B | oil A |
| | % | % | % | % | % | % | % |
| FA | (m/m) | (m/m) | (m/m) | (m/m) | (m/m) | (m/m) | (m/m) |
| C4:0 | ND | ND | ND | ND | ND | ND | ND |
| C6:0 | ND | ND | ND | ND | ND | ND | ND |
| C8:0 | ND | ND | ND | ND | ND | ND | ND |
| C10:0 | ND | ND | ND | ND | ND | ND | ND |
| C12:0 | ND | ND | ND | ND | ND | ND | 0.6 |
| C14:0 | ND | ND | ND | ND | ND | ND | ND |
| C16:0 | 10.5 | 8.3 | 11.5 | 17.3 | 10.0 | 8.7 | 10.1 |
| C18:0 | 4.3 | 21.1 | 9.0 | 7.7 | 41.4 | 30.2 | 20.0 |
| C18:1 | 42.8 | 27.6 | 32.5 | 46.9 | 32.0 | 40.4 | 50.0 |
| C18:2 | 16.9 | 13.3 | 38.7 | 16.3 | 8.9 | 10.8 | 13.4 |
| C18:3 | 0.8 | 9.5 | ND | 2.4 | ND | ND | ND |
| C20:0 | 2.6 | 3.7 | 0.9 | 1.7 | 4.8 | 3.5 | 1.5 |
| C20:1 | 7.5 | 2.7 | 0.8 | 1.4 | ND | 0.9 | 0.7 |
| C22:0 | 6.2 | 7.0 | 2.5 | 0.6 | ND | 1.9 | ND |
| C22:1 | 1.1 | ND | ND | ND | ND | ND | 1.6 |
| C24:0 | 4.4 | ND | 0.8 | ND | ND | 0.7 | ND |
| Rest FA | 2.8 | 6.9 | 3.4 | 5.7 | 3.0 | 3.1 | 2.2 |
| tot ≤ C12 | 0.0 | 0.0 | 0.0 | 0.0 | 0.0 | 0.0 | 0.6 |
| tot ≤ C14 | 0.0 | 0.0 | 0.0 | 0.0 | 0.0 | 0.0 | 0.6 |
| tot ≤ C16 | 10.5 | 8.3 | 11.5 | 17.3 | 10.0 | 8.7 | 10.7 |
| tot ≥ C16 | 97.1 | 93.2 | 96.6 | 94.3 | 97.0 | 96.9 | 97.3 |
| tot C10-C16 | 10.5 | 8.3 | 11.5 | 17.3 | 10.0 | 8.7 | 10.7 |

### Example 2: Free Fatty Acid Release from Lipids Upon Exposure to Native Patatin

In order to assess the stability of different lipids in the presence of patatin, a series of emulsions was prepared from 33 gram per liter demiwater solutions of patatin and an equal amount by weight of lipid. Fats were melted before use, oils were used as is.

TABLE 2
Free fatty acid formation of different lipids upon incubation
with patatin

| | | | mmol | |
|---|---|---|---|---|
| | | Incubation | FFA/kg | |
| Substrate | Patatin/blank | temperature | oil | pAv |
| Coconut oil | Blank | 20° C. | 2 | 0.13 |
| Coconut oil | patatin | 20° C. | 51 | 0.15 |
| Coconut oil | patatin | 40° C. | 89 | 0.76 |
| Corn oil | Blank | 20° C. | 2 | 0.13 |
| Corn oil | patatin | 20° C. | 31 | 0.26 |
| Vegetable fat A | Blank | 20° C. | 3 | 0.39 |
| Vegetable fat A | patatin | 20° C. | 43 | 0.40 |
| Vegetable fat B | Blank | 20° C. | 2 | 0.23 |
| Vegetable fat B | patatin | 20° C. | 53 | 0.39 |
| Grapeseed oil | patatin | 40° C. | 16 | 1.04 |
| Olive oil | Blank. | 20° C. | 4 | 1.28 |
| Olive oil | patatin | 20° C. | 12 | |
| Olive oil | patatin | 40° C. | 22 | 1.12 |
| Palm stearin | Blank | 20° C. | 8 | 2.16 |
| Palm stearin | patatin | 20° C. | 38 | 2.41 |
| Palm stearin | patatin | 40° C. | 104 | 6.68 |
| Peanut oil | patatin | 40° C. | 16 | 0.68 |
| Rapeseed oil | patatin | 40° C. | 11 | 0.56 |
| Red palm oil | patatin | 40° C. | 277 | 5.11 |
| Rice oil | Blank | 20° C. | 12 | |
| Rice oil | patatin | 40° C. | 41 | 1.00 |
| Sesame oil | patatin | 40° C. | 12 | 0.82 |
| Shea butter | Blank | 20° C. | 2 | |
| Shea butter | patatin | 20° C. | 28 | |
| Soybean oil | Blank | 20° C. | 2 | 0.23 |
| Soybean oil | patatin | 20° C. | 38 | 0.44 |
| Sunflower oil | Blank | 20° C. | 2 | 0.54 |
| Sunflower oil | patatin | 20° C. | 7 | |
| Sunflower oil | patatin | 40° C. | 15 | 0.65 |

The lipid and water were emulsified by means of an ultraturrax (T18 Ultraturrax with T18N dispersing tool) operating at 10 krpm for 1 minute and these emulsions were incubated at either ambient temperature (20° C.±0.2° C.) or at 40° C. for one day under mild agitation. Blanks were measured at room temperature.

The free fatty acid content of the oils was then determined by titration as described; The pAV was also determined. The results are provided in table 2.

The results in table 2 show that in all cases a higher incubation temperature results in a higher free fatty acid content, which serves as an accelerated test to establish free fatty acid development in a meat substitute. Furthermore, this shows that in food products in general, a higher preparation temperature results in faster free fatty acid development. A high free fatty acid content may cause off-taste, for example by the presence of free fatty acids or by further oxidation of free fatty acids.

### Example 3: Off-Flavor Formation in Patatin-Containing Emulsions Prepared with Various Lipids

Emulsions were prepared from a 10 wt. % solution of patatin in water, by emulsification of the lipid in a patatin solution:lipid wt. ratio of 1:2. The emulsions are tested for off-flavor formation by sensoric testing by a panel of trained sensoric testers. The tests were performed immediately after preparation, and after two days of storage at room temperature, mimicking an accelerated cool storage period. The results are shown in table 3.

The results show that lipids with the fatty acid content specified in the text do not result off-flavor immediately after preparation, and are stable to storage. Lipids not in line with this definition result in serious off-flavors immediately after preparation, which even gets worse upon storage.

TABLE 3
results of sensory tests on patatin-lipid emulsions

| | Off flavor | Of flavor |
|---|---|---|
| | after | after |
| Lipid | preparation* | storage* |
| Sunflower oil | − | − |
| Olive oil | − | − |
| Rapeseed oil | − | − |
| Rapeseed oil-hydrogenated | − | − |
| Corn oil | − | − |
| Soybean oil | − | − |
| Rice oil | − | − |
| Sesame oil | − | − |
| Peanut oil | − | − |
| Grapeseed oil | − | − |
| Vegetable fat A | − | − |
| Vegetable fat B | − | − |
| Coconut oil | ++ | +++ |
| Palm kernel oil | + | + |
| Red palm oil | + | + |

*− not detected;
+ detected;
++ medium off flavor;
+++ very strong off flavor

Based on the results of examples 2 and 3 combined, it can be concluded that off-taste does not develop provided that the pAV is maintained at 2 or less, preferably 1.5 or less, even more preferably 1 or less. In addition, it can be concluded that off-taste does not develop provided that the release of free fatty acids is generally less than 50 mmol/kg oil, preferably less than 40 mmol./kg oil.

### Example 4: Off-Flavor Formation in Patatin-Bound Meat Substitutes Prepared with Various Lipids

A series of raw-type meat substitutes was prepared using various lipids. The meat substitute was prepared according to the standardized recipe shown below, following a standardized procedure.

The textured plant protein was hydrated and subsequently mixed with the dry ingredients and the sunflower oil in a Hobart mixing machine. A further portion of the variable lipid was introduced (melted where necessary), and further mixed to obtain a homogenous mixture. The mixture was shaped into a burger patty and allowed to solidify.

| Ingredient | Mass % |
|---|---|
| Soy TVP | 21.0 |
| Water | 56.0 |
| Variable lipid | 8.0 |
| Sunflower oil | 3.0 |
| Solanic 200 | 5.0 |
| Potato starch | 3.0 |
| Potato fiber | 2.5 |
| Sodium salt | 1.0 |
| Dextrose | 0.5 |
| Total | 100.0 |

Off flavor formation was evaluated by sensoric testing by a panel of trained sensoric testers immediately after preparation, and after two days of storage at room temperature. These conditions mimic an accelerated cool storage period. The results are shown in table 4.

TABLE 4
off-flavor formation in meat substitutes prepared
with various lipids.

| | Off flavor | Off flavor |
|---|---|---|
| | after | after |
| Variable lipid | preparation* | storage* |
| Sunflower oil | − | − |
| Olive oil | − | − |
| Rapeseed oil | − | − |
| Rapeseed oil-hydrogenated | − | − |
| Corn oil | − | − |
| Soybean oil | − | − |
| Rice oil | − | − |
| Sesame oil | − | − |
| Peanut oil | − | − |
| Grapeseed oil | − | − |
| Vegetable fat A | − | − |
| Vegetable fat B | − | − |
| Coconut oil | +++ | +++ |
| Palm kernel oil | + | ++ |
| Red palm oil | + | ++ |

*− not detected;
+ detected;
++ medium off flavor;
+++ very strong off flavor

The results show that in meat substitutes which apply native patatin as a binder, lipids as specified herein suppress off-flavor formation.

### Example 5: Off-Flavor Formation in Bakery Products Prepared from Native Patatin in Combination with Various Lipids

As a model bakery product, vegan muffins were prepared. The same method may however be adapted using common general knowledge on the preparation of other bakery products, preferably vegan bakery products, in order to obtain bakery products such as a cookie, cake, pie, macaron, sponge cake, or waffle.

Vegan (egg-free) muffins were prepared by preparing a batter as a mixture comprising water, native patatin and various lipids.

Native patatin was introduced in the batter as pure native patatin (Solanic 200 (“S200”), commercially available from Avebe), or as a native potato protein mixture comprising a roughly 1:1 ratio of native patatin and native potato protease inhibitor (“PR mix”). The lipids used were sunflower oil (“SF”), a lipid according to the invention, and coconut oil (“Coco”), as a reference lipid.

The muffins were prepared on the basis of the following ingredients:

| | | | | Coco- |
|---|---|---|---|---|
| | SF- | SF-PR | Coco- | PR- |
| | S200 | mix | S200 | mix |
| Ingredient | (%) | (%) | (%) | (%) |
| Solanic 200 | 1.6 | / | 1.6 | / |
| PR-mix | / | 1.6 | / | 1.6 |
| Water | 23.8 | 23.8 | 23.8 | 23.8 |
| Coconut oil | / | / | 25.3 | 25.3 |
| Sunflower oil | 25.3 | 25.3 | / | / |
| wheat flour | 25.3 | 25.3 | 25.3 | 25.3 |
| Sugar | 22.8 | 22.8 | 22.8 | 22.8 |
| Emul 16 (emulsifier from Breatec) | 0.5 | 0.5 | 0.5 | 0.5 |
| SAPP28 (Disodium diphosphate | 0.3 | 0.3 | 0.3 | 0.3 |
| from Budenheim) | | | | |
| Sodium bicarbonate | 0.2 | 0.2 | 0.2 | 0.2 |
| Salt (NaCl) | 0.2 | 0.2 | 0 2 | 0.2 |
| Total | 100.0 | 100.0 | 100.0 | 100.0 |

The muffins were prepared by mixing the dry ingredients into a homogenous mixture at room temperature (20° C.), adding the lipid and the water to the dry mixture, and mixing this for two minutes into a batter with a smooth and silky appearance.

The batter was introduced into paper cups in portions of about 50 ml. The total time in which the native patatin was in contact with the lipid at room temperature was about ten minutes.

The paper cups with batter were subsequently baked for 33 minutes in an oven (Probat) at a temperature of 195° C. in the upper part and 185° C. in the bottom part, with an open valve for the last 5 minutes.

In line with common general knowledge on the preparation of bakery products, the heating temperature is the outside (oven) temperature; the core temperature of the bakery product will gradually rise during the baking period to about 95° C., at which point the bakery product is ready. This leaves a significant period in which the lipid is in contact with native patatin at increased temperature, which period is associated with accelerated off-flavor formation, prior to the denaturation of patatin at the highest temperatures.

The sensory characteristics of the batter after preparation and of the muffin after baking were evaluated by a panel of trained experts in line with general practice in the food industry.

| Ingredient | SF-S200 | SF-PRmix | Coco-S200 | Coco-PRmix |
|---|---|---|---|---|
| After mixing | − | − | ++ | + |
| After baked | − | − | +++ | ++ |

*The intensity of the detected off-smell is ranked from “+” (low intensity) to “+++++” (very strong intensity);
“−”: means not detectable.

The results show that both the batters (before baking) as well as the muffins (after baking) comprising patatin and coconut oil have off-flavors, while the batters comprising patatin and the lipid of the invention, as well as muffins prepared therefrom, do not have off-flavors. Patatin in combination with a lipid as specified in the text do not result in any off-taste in bakery product, not in the batter, nor after baking. In addition, the results confirm that off-flavors develop in an accelerated fashion by creating a situation in which native patatin is in contact with those lipids not according to the invention at an increased temperature. This can be avoided by applying a lipid of the invention, thereby preventing off-flavor formation.

1. A method for making a meat substitute, comprising
a) providing a mixture comprising water, a denatured protein, native patatin and a lipid, which lipid is defined as a substance comprising fatty acid tri-esters of glycerol;
b) shaping the meat substitute; and
c) cooling the meat substitute to a temperature of from −35° C. to 20° C.;
wherein the fatty acids in said lipid comprise less than 2% by mass of fatty acids having a chain length of C12 or less, and wherein the denatured protein is a denatured plant protein derived from a tuber, cereal or nut, or a denatured plant protein selected from the group consisting of soy protein, faba bean protein, mungbean protein, mushroom protein, chick pea protein and lentil protein.

2. A method according to claim 1, wherein the fatty acids comprise less than 2% by mass of fatty acids having a chain length of C14 or less.

3. A method according to claim 1, wherein at least 98% by mass of the fatty acids are fatty acids having a chain length of C12 or higher, preferably C14 or higher.

4. A method according to claim 1, wherein the lipid comprises one or more of the lipids in the group of corn oil, soybean oil, rapeseed oil, sunflower oil, grape seed oil, peanut oil, sesame oil, olive oil, shea butter, cocoa butter, and rice bran oil, which lipids may optionally have been hydrogenated.

5. A method according to any of claim 1, wherein the lipid provided to the mixture comprises less than 18 mmol per kg lipid of free fatty acids, and/or wherein the total of diacylglycerols and monoacylglycerols, relative to the total lipid, is less than 10 wt. %.

6-9. (canceled)

10. A method according to claim 5, wherein the meat substitute is not heated to a temperature above 60° C. prior to cooling.

11. A method according to claim 10, wherein the meat substitute is generally kept at a temperature of from −35° C. to 20° C. throughout the period until cooking the meat substitute, which period is preferably 1-14 days, and wherein after the period until cooking and prior to consumption, the meat substitute is heated to a temperature of at least 75° C. for a period of at least 1 minute.

12. (canceled)

13. A method according to claim 10, further comprising including in the mixture one or more salts, such as a salt selected from the group consisting of sodium, potassium or calcium chloride, sodium or potassium glutamate and calcium sulfate, and/or one or more pigments, such as a pigment selected from the group consisting of heme-like pigment, red beet pigment, carotene, caramel, beet juice extract, tomato pigment, radish pigment, paprika pigment and amaranth, and/or one or more fibers, such as a fiber selected from the group consisting of potato fiber, sweet potato fiber, carrot fiber, psyllium fiber, bamboo fiber, soybean fiber, pea fiber, mungbean fiber, tapioca fiber, coconut fiber, banana fiber, cellulose, resistant starch, resistant dextrins, inulin, lignin, chitin, pectin, beta-glucan, and oligosaccharide, and/or one or more texturisers such as a texturizer selected from the group consisting of native starch, modified starch, cellulose derivatives, carrageenan, alginate, agar, konjac, xanthan, and pectin, and/or one or more flavor development aids selected from the group consisting of dextrose, ribose and maltodextrin, and/or one or more flavorings, such as a sweetener selected from the group consisting of sucrose, glucose, fructose, syrup, and artificial sweeteners.

14.-17. (canceled)

18. A meat substitute obtainable by the method of claim 1.

19. A meat substitute comprising water, native patatin, a denatured protein and a lipid, which lipid is defined as a substance comprising fatty acid tri-esters of glycerol, wherein the fatty acids in said lipid comprise less than 2% by mass of fatty acids having a chain length of C12 or less, and wherein the denatured protein is a denatured plant protein derived from a tuber, cereal or nut, or a denatured plant protein selected from the group consisting of soy protein, faba bean protein, mungbean protein, mushroom protein, chick pea protein and lentil protein, and wherein the fatty acids comprise less than 2% by mass of fatty acids having a chain length of C14 or less.

20-23. (canceled)

24. A meat substitute according to claim 19, wherein at least 98% by mass of the fatty acids are fatty acids having a chain length of C12 or higher, preferably C14 or higher.

25. A meat substitute according to claim 24, wherein the lipid comprises one or more of the lipids in the group of corn oil, soybean oil, rapeseed oil, sunflower oil, grape seed oil, peanut oil, sesame oil, olive oil, shea butter, cocoa butter, and rice bran oil, which lipids may optionally have been hydrogenated.

26. (canceled)

27. A meat substitute according to claim 25, wherein the lipid comprises less than 18 mmol per kg lipid of free fatty acids, and/or wherein the total of diacylglycerols and monoacylglycerols, relative to the total lipid, is less than 10 wt. %.

28. A meat substitute according to claim 27, further comprising one or more salts, such as a salt selected from the group consisting of sodium, potassium or calcium chloride, sodium or potassium glutamate and calcium sulfate, and/or one or more pigments, such as a pigment selected from the group consisting of heme-like pigment, red beet pigment, carotene, caramel, beet juice extract, tomato pigment, radish pigment, paprika pigment and amaranth, and/or one or more fibers, such as a fiber selected from the group consisting of potato fiber, sweet potato fiber, carrot fiber, psyllium fiber, bamboo fiber, soybean fiber, pea fiber, mungbean fiber, tapioca fiber, coconut fiber, banana fiber, cellulose, resistant starch, resistant dextrins, inulin, lignin, chitin, pectin, beta-glucan, and oligosaccharide, and/or one or more texturisers such as a texturizer selected from the group consisting of native starch, modified starch, cellulose derivatives, carrageenan, alginate, agar, konjac, xanthan, and pectin, and/or one or more flavor development aids selected from the group consisting of dextrose, ribose and maltodextrin, and/or one or more flavorings, such as a sweetener selected from the group consisting of sucrose, glucose, fructose, syrup, and artificial sweeteners.

29-32. (canceled)

33. The method according to claim 1, wherein the denatured plant protein is potato protein, sweet potato protein, wheat protein/gluten, oat protein, spelt protein, sesame seed protein, hemp seed protein or soy protein.

34. The method according to claim 1, wherein the denatured plant protein is a texturized plant protein, preferably texturized soy protein, texturized potato protein or texturized gluten.

35. The meat substitute according to claim 19, wherein the denatured plant protein is potato protein, sweet potato protein, wheat protein/gluten, oat protein, spelt protein, sesame seed protein, hemp seed protein or soy protein.

36. The meat substitute according to claim 19, wherein the denatured plant protein is a texturized plant protein, preferably texturized soy protein, texturized potato protein or texturized gluten.
